(19) United States
(12) Patent Application Publication
(10) Pub. No.: US 2016/0188587 A1
(43) Pub. Date: Jun. 30, 2016

(54) METHODS AND SYSTEMS FOR PROVIDING EXPERT MEDIA CONTENT SESSIONS

(71) Applicants: MICHAEL MARTIN, PALO ALTO, CA (US); CHANDRASEKHAR KALLE, FREMONT, CA (US); RAJESH SETTY, SAN JOSE, CA (US)

(72) Inventors: MICHAEL MARTIN, PALO ALTO, CA (US); CHANDRASEKHAR KALLE, FREMONT, CA (US); RAJESH SETTY, SAN JOSE, CA (US)

(21) Appl. No.: 14/885,995

(22) Filed: Oct. 16, 2015

Related U.S. Application Data
(60) Provisional application No. 62/065,234, filed on Oct. 17, 2014.
(60) Provisional application No. 62/242,986, filed on Oct. 16, 2015.

(51) Int. Cl. G06F 17/30; H04L 29/08

(52) U.S. Cl. CPC G06F 17/30029; G06F 17/3053; G06F 17/30094; G06F 17/30106; G06F 17/30867; G06F 17/30876; H04L 67/06

(57) ABSTRACT

In one aspect, a method obtains a set of expert-media content files and an index of the set of expert-media content files. A set of user attributes are obtained. A request from user-side application to download an expert-media content file is received. The set of expert-media content files, the index of the set of expert-media content computer data store, the request to download the expert-media content file and the set of user attributes are stored in a computerized data store. With the processor of a server it implementing delivering predictive expert-media content to the user's mobile device, the set of expert-media content files, the index of the set of expert-media content files in a computer data store, the request to download the expert-media content file and the set of user attributes are extracted from the computerized data store. With a recommendation engine operating in the server, the index of the set of expert media-content files is ranked based on the set of user attributes. A first-listed expert media-content file of the ranked index of the set of expert-media content files is obtained. The first-listed expert media-content file is electronically communicate to the user-side application.

### CROSS-REFERENCE TO RELATED APPLICATIONS

This application is a claims priority from provisional U.S. application Ser. No. 62/065,234 filed 17 Oct. 2014. This application is hereby incorporated by reference in its entirety. This application is a claims priority from provisional U.S. application Ser. No. 62/242,986 filed 16 Oct. 2015. This application is hereby incorporated by reference in its entirety.

### FIELD OF THE INVENTION

The invention is in the field of digital media content and more specifically to a method, system and apparatus of methods and systems of expert-media content sessions.

### DESCRIPTION OF THE RELATED ART

Users can benefit from expert perspectives and advice. Currently, users may search for particular expert advice topics on the Internet and/or purchase books on various topics. When a user searches for expert advice, the search engine can return a large number of results. Similarly, thousands (if not tens of thousands) of books on self-help and expert advice topics are available.

At the same time, user attributes (e.g. demographics attributes, behavioral attributes, user context, etc.) are available via various digital sources. For example, user context can be determine from information from a user's mobile device. in another example, user interest can be determined from a user's search engine results and/or product purchase history. Accordingly, user attributes can be mapped with various available expert advice topics.

Additionally, experts may want to distribute their advice in a digital manner. In this way, experts can obtain valuable metrics of how said expert advice is received by the public. Therefore, improvements to the provision of expert advice via mobile devices can improve both a user's experience, as well as that of an expert advice provider as well.

### BRIEF SUMMARY OF THE INVENTION

In one aspect, a method obtains a set of expert-media content files and an index of the set of expert-media content files. A set of user attributes are obtained. A request from a user-side application to download an expert-media content file is received. The set of expert-media content files, the index of the set of expert-media content files in a computer data store, the request to download the expert-media content file and the set of user attributes are stored in a computerized data store. With the processor of a server implementing delivering predictive expert-media content to the user's mobile device, the set of expert-media content files, the index of the set of expert-media content files in a computer data store, the request to download the expert-media content file and the set of user attributes are extracted from the computerized data store. With a recommendation engine operating in the server, the index of the set of expert media-content files is ranked based on the set of user attributes. A first-listed expert media-content file of the ranked index of the set of expert-media content files is obtained. The first-listed expert media-content file is electronically communicate to the user-side application.

### BRIEF DESCRIPTION OF THE DRAWINGS

FIG. 1 illustrates an example system for providing expert media content sessions, according to some embodiments.

FIG. 2 depicts computing system with a number of components that may be used to perform any of the processes described herein.

FIG. 3 illustrates an example method of a content recommendation system, according to some embodiments.

FIG. 4 illustrates an example method of predictive expert media content buffering in a mobile device, according to some embodiments.

FIG. 5 illustrates a process of adaptive push notifications, according to some embodiments.

FIG. 6 illustrates an example process of realtime participation in live events using mobile devices, according to some embodiments.

FIG. 7 illustrates an example process of realtime scheduling of phone calls using mobile devices, according to some embodiments.

The Figures described above are a representative set, and are not an exhaustive with respect to embodying the invention.

### DESCRIPTION

Disclosed are a system, method, and article of providing expert media content sessions. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to “one embodiment,” “an embodiment,”‘one example,’ or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Machine learning systems can include systems that can learn from data, rather than follow explicitly programmed instructions. Machine learning systems can implement various machine learning algorithms, such as, inter alia: supervised learning, unsupervised learning (e.g., artificial neural networks, hierarchal clustering, cluster analysis, association rule learning, etc.), semi-supervised learning, transductive inference, reinforcement learning, deep learning, etc.

Mobile device can include smart phones, cell phones, personal digital assistants, tablet computers, wearable computers, smart watches, smart glasses (e.g. Google®), etc.

Predictive analytics can include a variety of statistical techniques from modeling, machine learning, and data mining that analyze current and historical facts to make predictions about future, or otherwise unknown, events.

Push notification can be a style of Internet-based communication where the request for a given transaction is initiated by the publisher or central server. Push notifications can include HTTP server push notifications, pushlet notifications, etc.

### Exemplary Systems and Computer Architecture

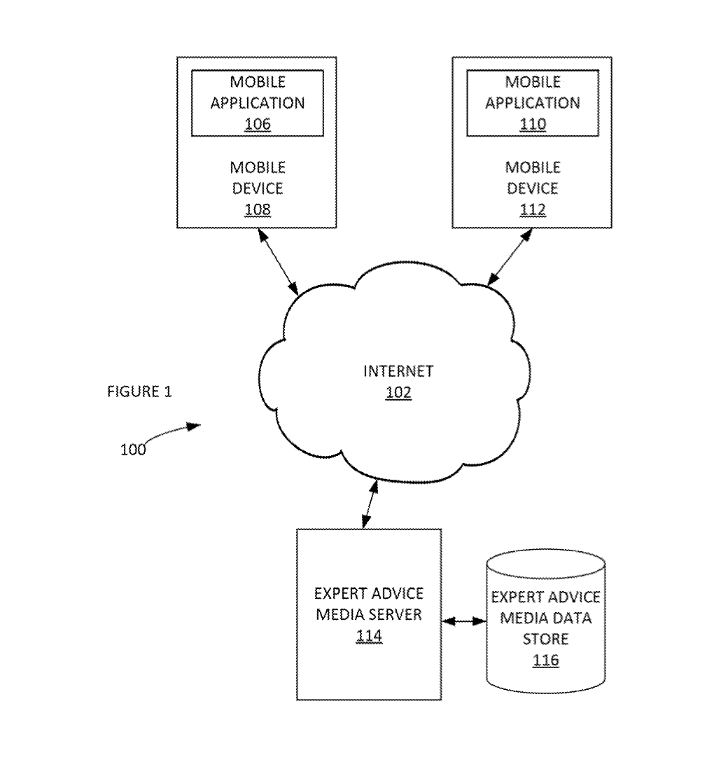

FIG. 1 illustrates an example system 100 for providing expert media content, according to some embodiments. System 100 can include various computer systems communicatively coupled via the Internet 102 (and/or other computer and/or cellular data networks). For example, system 100 can include one or more user mobile devices 108. User mobile device(s) 108 can be a user-side computing device with operating system (OS), and can run various types of application software (‘apps’). Mobile devices can include Wi-Fi, Bluetooth, and GPS capabilities that can allow connections to the Internet, etc. Example mobile devices include, inter alia, smart phones, head-mounted display computers (e.g. Google Glass®), tablet computers, other wearable computers (e.g. smartwatches), and the like. In some example embodiments, other user-side computing systems (e.g. laptops, personal computers, etc.) can implement the functionalities attributed to mobile devices. User mobile device 108 can include an application 106 for obtaining and viewing/listening to expert advice sessions.

Application 106 can include various functionalities for obtaining expert advice sessions, displaying expert advice sessions to one or more users, obtaining user feedback about said expert advice sections, enabling a user to communicate with experts via the Internet (e.g. viv a videotelephony and/or audio-telephony functionality, an instant messaging and/or video chat platform, etc.) Application 106 can also mine the mobile device for information about the user. For example, application 106 can access user text messaging, email contact lists, web browser history, etc. to obtain information about a current state (e.g. user plans, user intentions, user motions, etc.). Application 106 can provide this information to expert advice media server 114 for analysis. Application 106 can include a search engine functionality for searching databases such as expert advice media data store 116 infra.

Expert device media server 114 can include functionalities for streaming and/or otherwise communicating expert advice audio sessions to a user's mobile device 108. Expert advice media server 114 can include functionalities obtaining user attributes and/or user state information from the user's mobile device 108 and/or other sources (e.g. user email accounts, user-provided demographic data, third party data sources, user's expert advice media consumption patterns, etc.). In some examples, application 106 can include some of the functionalities of expert advice media server 114 and vice versa.

Expert advice media server 114 can include a content recommendation engine. Content recommendations can be done, for example, using collaborative and/or content-based filtering. Content recommendation engine build a model from a user's past behavior (e.g. expert advice sessions items previously watched/listened to or selected and/or numerical ratings given to those expert advice sessions by the user) as well as similar decisions made by other users. Content recommendation engine then use this model to predict expert advice sessions (or ratings for items) that the user may have an interest in. Content-based filtering approaches utilize a series of discrete characteristics of an item in order to recommend additional items with similar properties. These approaches are often combined (e.g. as a hybrid recommender systems). Content recommendation engine can also use user attributes and/or user state information as input into the collaborative filtering and/or content-based filtering models.

Expert advice media server 114 can include functionalities for adaptive push notifications. For example, expert advice media server 114 can use push technology through a constantly open internet protocol (IP) connection to forward notifications applications 106 and/or 112. Push notifications can include notifications may include badges, sounds or custom text alerts, and the like. Machine learning techniques can be implemented to determine optimal times, content and/or formats of said push notifications. Accordingly, rules for implementing push notification processes (as well as other processes herein such as content recommendation, etc.) can be both explicitly defined by an administrator/curator and/or algorithmically learned without being explicitly programmed. Example machine learning approaches that can be implemented, include inter alia: decision tree learning, association rule learning, artificial neural networks, inductive logic programming, support vector machines, clustering, Bayesian networks, reinforcement learning, representation learning, similarity and metric learning, sparse dictionary learning, etc.

Expert advice sessions can be downloaded to the mobile device 108 as audio and/or video files well as other formats such as PDF documents, PowerPoint presentations, etc.). Expert advice media server 114 can include functionalities for the predictive buffering of expert media sessions (e.g. predictive buffering of audio files). Expert advice sessions can be designed to be reviewed by the user in short (e.g. three minutes, five minutes, etc.) sessions. Expert advice sessions can be generated by various experts in various fields. Expert advice sessions media files can include metadata about the expert, advice content, time length, target user attributes, etc. Expert advice sessions can be stored in expert advice media data store 116.

System 100 can also include an expert-side mobile device 110 and application 112. Application 112 can be configured to enable an expert to record and upload expert advice sessions in various media formats. Application 112 can be configured to enable an expert to view system statistics (e.g. with respect to his/her expert media sessions). Application 112 can be configured to enable an expert to broadcast live expert media sessions to a plurality of user-side application(s) 106 and/or receive questions from said user-side application(s) 106. Application 112 can also include billing functionalities whereby an expert can bill for his/her time/actions. For example, an expert can bill on a per-minute basis to answer user questions. Applications 106 and/or 112 can include telephony applications (e.g. a Virtual PBX phone service) that enables users and experts to interact. Applications 106 and/or 112 can include calendaring and/or other scheduling applications for the scheduling of billable user/expert interactions. Expert advice media server 114 can manage ephemeral offers via Applications 106 and/or 112 (see infra). Expert advice media server 114 can include a web server and/or other user interface managers for implementing the various user interfaces provided herein. Expert advice media server 114 can include various social networking functionalities (e.g. photo sharing, microblogs, status updates, etc.) for cohesive sharing experience with respect to expert advice sessions.

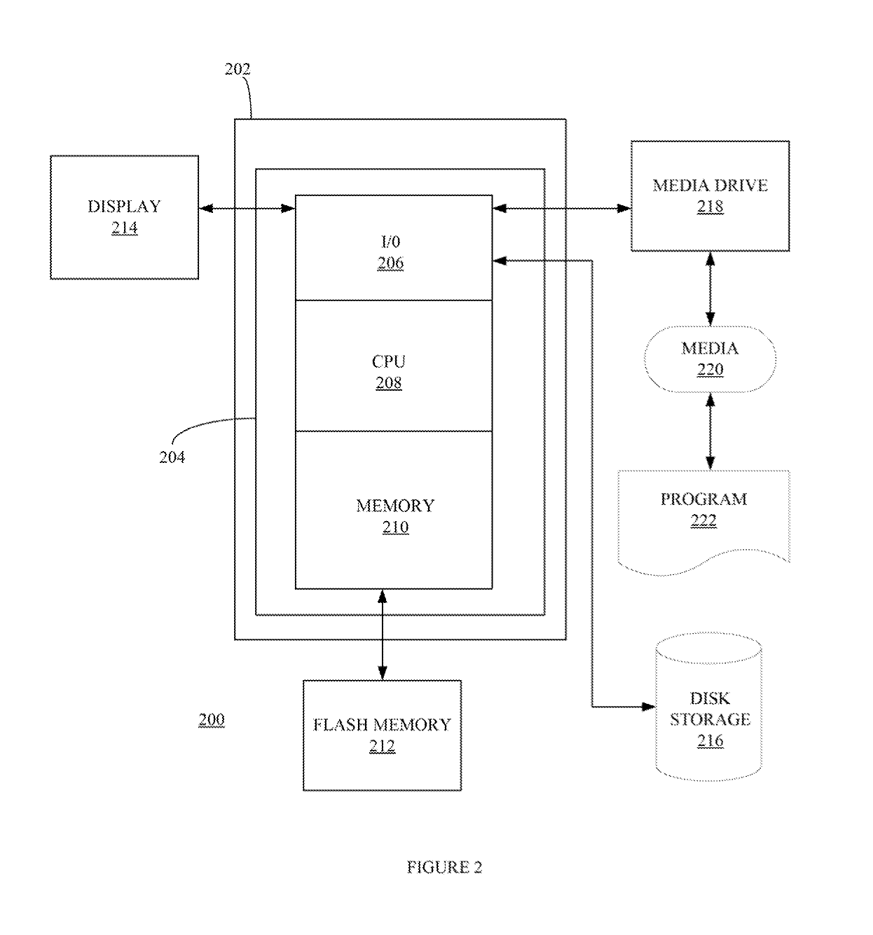

FIG. 2 depicts an exemplary computing system 200 that can be configured to perform any one of the processes provided herein. In this context, computing system 200 may include, for example, a processor, memory, storage, and I/O devices (e.g., monitor, keyboard, disk drive, Internet connection, etc.). However, computing system 200 may include circuitry other specialized hardware for carrying out some or all aspects of the processes. In some operational settings, computing system 200 may be configured as a system that includes one or more units, each of which is configured to carry out some aspects of the processes either in software, hardware, or some combination thereof.

FIG. 2 depicts an exemplary computing system 200 with a number of components that may be used to perform any of the processes described herein. The main system 202 includes a motherboard 204 having an I/O section 206, one or more central processing units (CPU) 208, and a memory section 210, which may have a flash memory card 212 related to it. The I/O section 206 can be connected to a display 214, a keyboard and/or other user input (not shown), a disk storage unit 216, and a media drive unit 218. The media drive unit 218 can read/write a computer-readable medium 220, which can contain programs 222 and/or data. Computing system 200 can include a web browser. Moreover, it is noted that computing system 200 can be configured to include additional systems in order to fulfill various functionalities. Computing system 200 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

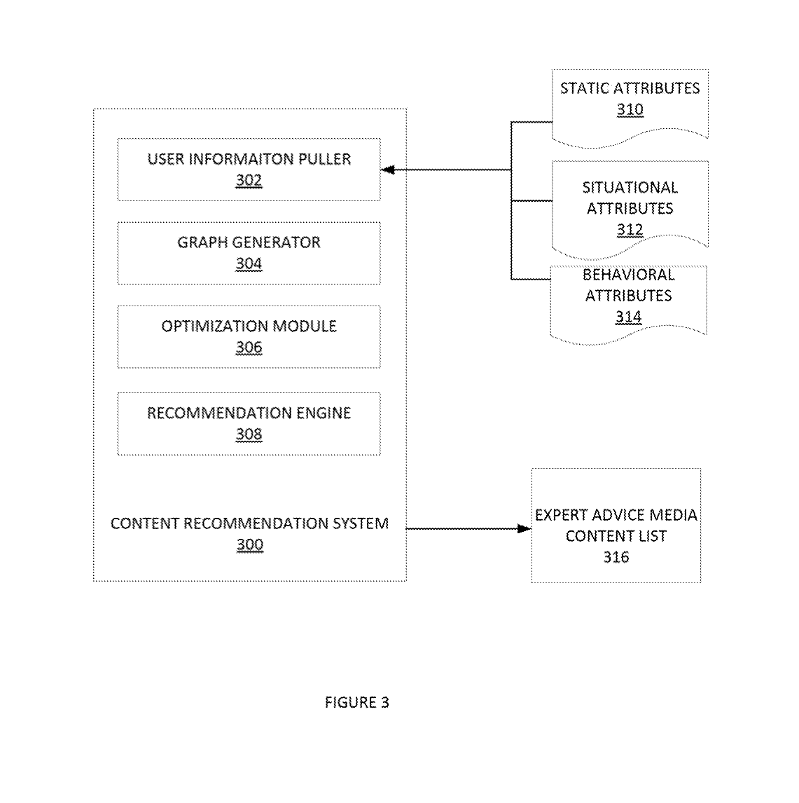

FIG. 3 illustrates an example method of a content recommendation system 300, according to some embodiments. Content recommendation system 300 can learn various user attributes (e.g. interests/mood). Content recommendation system 300 can recommend insightful expert advice content that user may like at any given point in time based on a number of factors about the user at a given instant of time. Content recommendation system 300 can track various static and dynamic attributes about a user, such as, inter alia: static attributes 310 (e.g. age, race, gender, eight, height, etc.); situational attributes 312 (e.g. user looking for a job; going to an important meeting about a sales partnership; thinking of starting a business; stressed); behavioral attributes 314 (e.g., user likes biking, Asian food, chocolate, Armani suits, uses Tinder® (or other matchmaking applications), Linkedin® (or other online social networking services) quite frequently; plays squash, tennis, etc.). In one example, user information puller 302 can utilize various data mining techniques and methods to obtain the user attributes. User information puller 302 can utilize applications operating in a user's mobile device to access other applications (e.g. text messaging, email, chat, web browser, etc.) to access various user attribute information.

These attributes are used to create various graphs about the user by graph generator 304. These graphs can be based on static, situational and behavioral attributes. Multiple graphs can be created for each set of attributes. Graphs and/or other user attribute information can be provided to recommendation engine 308. Recommendation engine 308 match user attributes to expert advice session media. Optimization module 306 can optimize the various techniques of recommendation engine 308. Various computational optimization algorithms can be utilized, such as, inter alia: simplex algorithm and its extension, combinatorial algorithms, Newton's method, quasi-Newton method, finite difference, approximation theory, numerical analysis, interpolation methods, pattern search methods, etc. In one example, recommendation engine 308 can feed the graphs into one or more machine learning algorithms for predictive analytics. Example predictive analytics methods that can be implemented include, inter alia: regression techniques, linear regression models, logistic regression models, time series models, multinomial logistic regression, etc. Machine learning systems in the Recommendation engine 308 can analyze a user's static attributes, situational attributes, and behavioral attributes to recommend the most useful content the user might like to see at the present moment. Once recommendation engine 308 arrives at a prediction, it may issue a push notification to the user in real-time, so that the most relevant insight may be surfaced at the most appropriate instant in time. For example, if recommendation engine 308 learns that the user who is looking for a job is driving on his way to an interview, it might issue a push notification recommending all insights relevant to job interviews, relevant to the company he is interviewing with, position he interview interviewing for, and the like. Accordingly, an expert media content list 318 that is relevant to the user's attributes and/or current state can be generated and provided to the user's mobile device application. This content can then be retrieved and played for the user. Expert media content list 318 can be a sorted/ranked list with higher ranked (e.g. more like for a user to listen to) expert media content at the top of the list.

### EXAMPLE METHODS

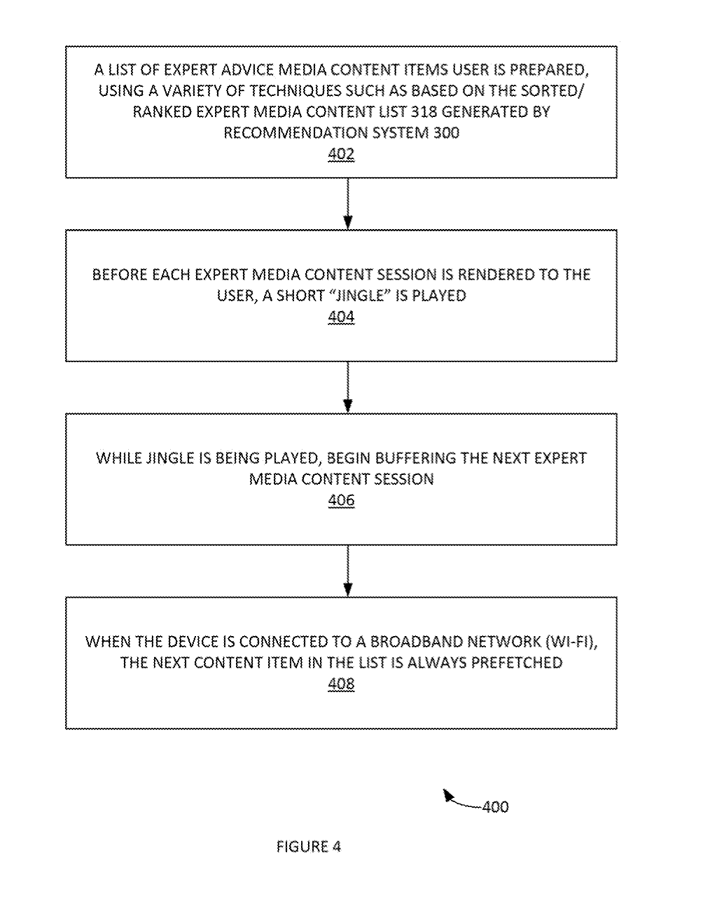

FIG. 4 illustrates an example method 400 of predictive expert media content buffering in a mobile device, according to some embodiments. Mobile device application 106 can implement a predictive approach to buffering that utilizes pockets of time to pre-fetch content from expert advice media server 114. First, in step 402 of process 400, a list of expert advice media content items user may like to play are prepared, using a variety of techniques such as based on the sorted/ranked expert media content list 318 generated by recommendation system 300. This is the list user can play in a sequential manner. In step 404, before each expert media content session is rendered to the user, a short “jingle” can be played. In step 406, while the jingle is being played, the buffering is started, so that there is no delay when the actual content item begins to play. Net result of this optimization is that the user does not experience any delay when going from one content item to another. Second, in step 408, when the device is connected to a broadband network (Wi-Fi), the next content item in the list is always pre-fetched. Opportunistically, the next fifteen (15) minutes of content items may be pre-fetched while in this mode, so that when the device switches to a data plan, there is less need for data transfer thus saving cost of wireless plan data transfer to the user. Here, the assumption is made that wireless data cost is higher than broadband data cost. If not, then step 410 can be implemented each time. Mobile device application 106 can automatically detects when the mobile device 108 is in WiFi mode as opposed to data mode.

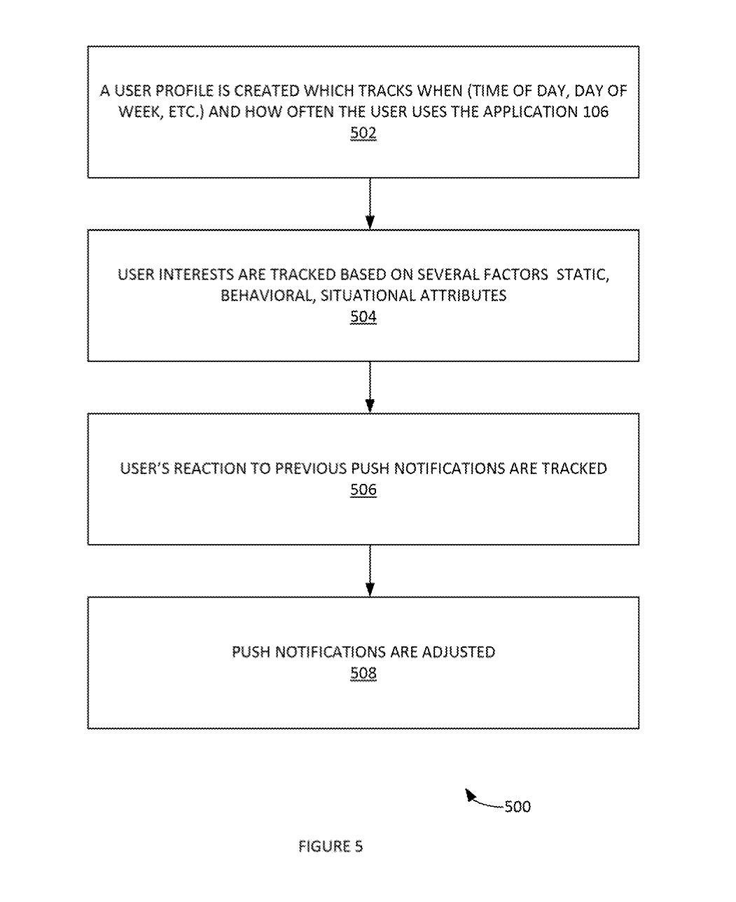

FIG. 5 illustrates a process 500 of adaptive push notifications, according to some embodiments. First, in step 502, a user profile is created which tracks when (time of day, day of week, etc.) and how often the user uses the application 106. Second, in step 504, user interests are tracked based on several factors—static, behavioral, situational attributes. Third, in step 506, a user's reaction to previous push notifications are tracked. Questions that can be determined, include: is the user actually responding to a push notification and/or clearing the notification without responding to it. Based on these factors, in step 508, the push notifications are adjusted, such as, inter alia the following. A notification is issued when new content items that match user interests are found, at a time when user normally opens the app. The notification is issued when user is about to do something for which a content item may be most relevant, such as driving to a job interview (in which case push notification related to job interviews may be issued). The notifications for a given topic are suspended, if the user stops responding to push; notifications for that topic; notifications are suspended for extended periods of time if the user does not respond to any notifications from the app for a consecutive number of attempts.

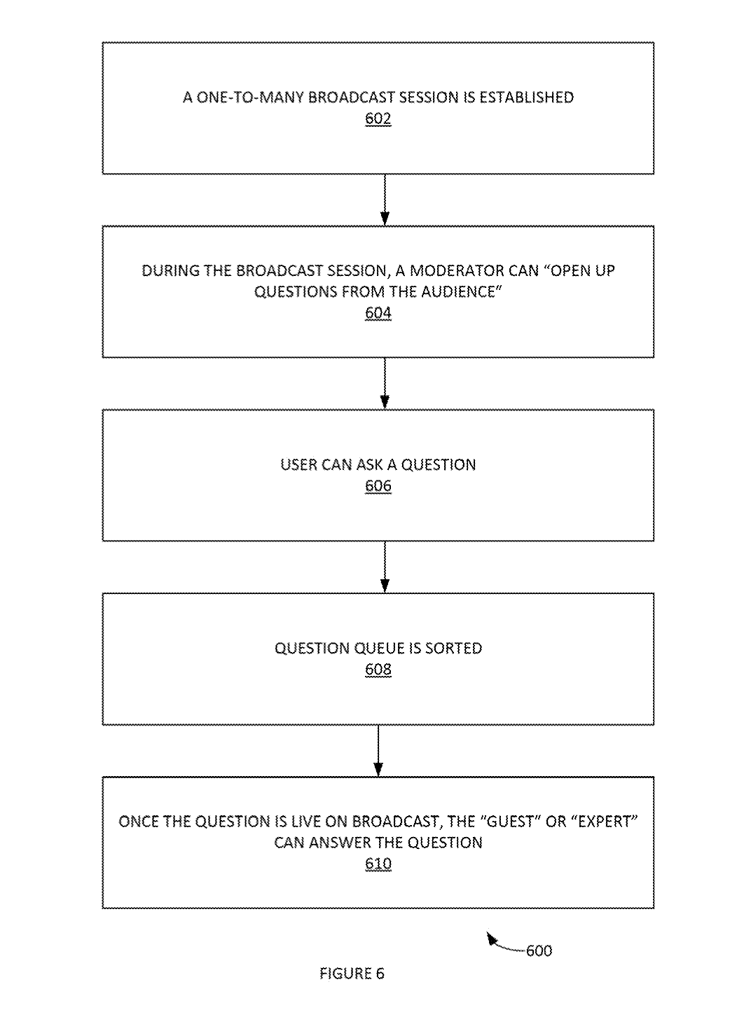

FIG. 6 illustrates an example process 600 of realtime participation in live events using mobile devices, according to some embodiments. First, in step 602, a one-to-many broadcast session is established with an instant messaging and video chat platform (e.g. similar to a Google Hangout® but with an audio setting). There can be one or more “hosts” interviewing one “guest” or “expert” on one or many “topics”. End users can listen to the live broadcast using their mobile device. In step 604, during the broadcast session, a moderator can “open up questions from the audience” at any given time. Once the session is open for questions, in step 606, end user can push a button on their mobile device and speak to ask a question. Alternatively, the end user can either type in a question or enter it in many ways. Once the question is complete, it goes into a queue of questions. In step 608, the queue may be sorted in several ways. For example, based on such factors as, inter alia: whether the person posing the questions, is a free user or a premium user, how many credits the user has, how many ratings a user has made, etc. The moderator on the other side can optionally review each question and “release” it to the broadcast. In step 610, once the question is live on broadcast, the “guest” or “expert” can answer the question. Optionally, the question may be transmitted privately to the guest and/or host only.

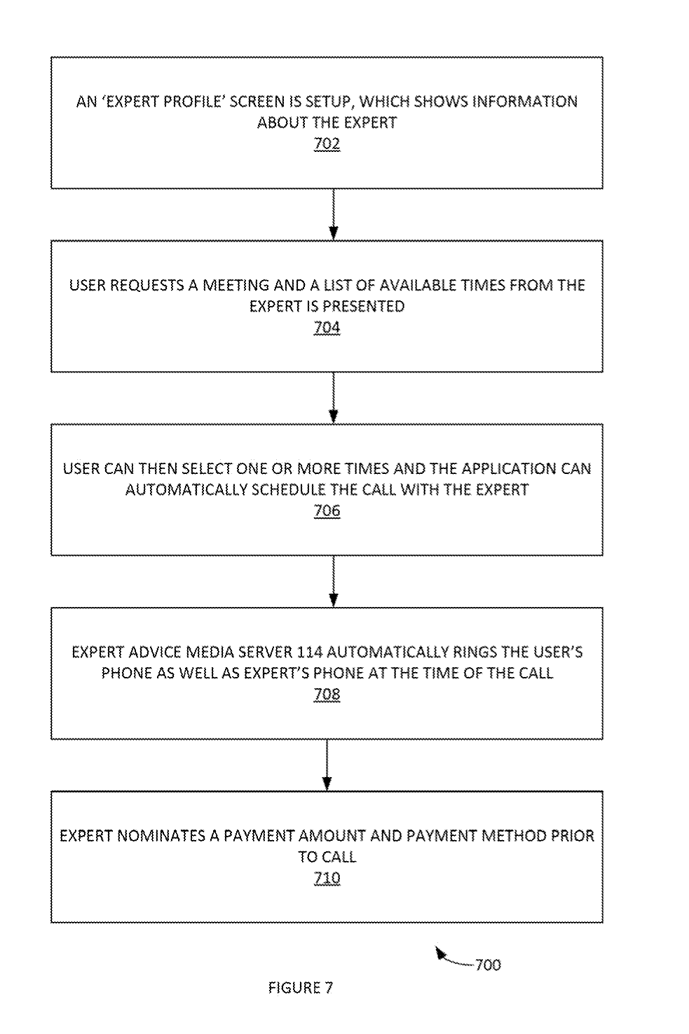

FIG. 7 illustrates an example process 700 of realtime scheduling of phone calls using mobile devices, according to some embodiments. Each expert in the system can have a set of users that qualify as an audience (e.g. users have listened to a specified threshold of expert media content sessions, user has rated the expert highly, etc.). Because users like the experts and/or the expert's media content, the user may like to schedule a one-to-one time with the experts (e.g. via mobile phone application). First, in step 702 of process 700, an ‘expert profile’ screen is setup, which shows information about the expert (e.g. expert's title, biography, accomplishments, etc.) In the “expert profile”, a “schedule phone call” button is added. In step 704, when user clicks on this button, a list of available times from the expert is presented. In step 706, the user can then select one or more times and the application can automatically schedule the call with the expert. In step 708, expert advice media server 114 automatically rings the user's phone as well as expert's phone at the time of the call. The service hides the user's and expert's phone number and keeps it anonymous. Additionally, the service may remind the user and/or the expert some time before the call is scheduled to begin. In step 710, the expert may nominate payment amount and payment method prior to the call. For example, an expert may nominate an amount such as “I charge $1 per minute” and payment method such as “Proceeds go to Charity Water” or “Proceeds go to my bank account”. The service may charge a transaction fee which could be a fixed cost or a percentage of the transaction amount of the call as service fees.

### EXAMPLE USE CASES

Various use case examples of the methods and systems of (such as those provided in FIGS. 1-7 for example) providing expert media content sessions. In one example, ephemeral offers can be provided the on mobile devices (e.g. utilizing applications 106 and/or 110). As with process 700, respective experts utilizing system 100 can each have a set audience of users. First, an expert profile screen can be setup. The expert screen profile can display information about the expert (e.g. see supra). In the displayed expert profile, one or more exclusive offers may be added by the expert. Each offer may be exclusive only to the users of application 106. Examples of offers include, inter alia: $50 off a particular copyrighted material (e.g. a book, audio book, video, etc.); 30% off a particular copyrighted material; free or discounted access to an event or more offers. There is no limit to the number or type of offers an expert may offer. User can click on an offer to claim the offer. Once the user claims the offer, the service may render the offer to the user in one or many ways (e.g. as email a discount code to the user, text a pass to the user, etc.). The user can use the discount code or coupon easily from his mobile device. Optionally the expert or the service may set a deadline to claim the offer to the user, such as “expires in 30 minutes”, “expires in 24 hours”, or “expires in 5 minutes”. Optionally, the offer may be different to different users, based on their profiles. In addition, the offer may be presented as an exclusive “surprise” to the user. It is noted that this example is provided by way of example and of limitation.

In some examples, system 100 and application 106 can provide cohesive sharing experience on mobile devices, according to some embodiments. The screen shots of the provisional applications incorporated herein by reference illustrate various examples of simple sharing experience that makes it seamless to share content on social networks or with specific people in user's address book.

### CONCLUSION

Although the present embodiments have been described with reference to specific example embodiments, various modifications and changes can be made to these embodiments without departing from the broader spirit and scope of the various embodiments. For example, the various devices, modules, etc, described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictivity. In some embodiments, the machine-readable medium can be a non-transitory form of machine-readable medium.

What is claimed as new and desired to be protected by Letters Patent of the United States is:

1. A method of delivering predictive expert-media content to a user's mobile device comprising executing on a processor the steps of:
obtaining a set of expert-media content files and an index of the set of expert-media content files;
obtaining a set of user attributes;
receiving a requires user-side application to download an expert-media content file;
storing the set of expert-media content files, the index of the set of expert-media content files in a computer data store, the request to download the expert-media content file and the set of user attributes in a computerized data store;
with the processor of a server implementing delivering predictive expert-media content to the user's mobile device:
extracting the set of expert-media content files, the index of the set of expert-media content files in a computer data store, the request to download the expert-media content file and the set of user attributes from the computerized data store;
with a recommendation engine operating in the server, ranking the index of the set of expert media-content files based on the set of user attributes; and
obtaining a first-listed expert media-content file of the ranked index of the set of expert-media content files; and
electronically communicating the first-listed expert media-content file to the user-side application.

2. The method of claim 1, wherein the expert media content file is limited to three (3) minutes of audio or video content.

3. The method of claim 2, wherein the user-side media application comprises a smart-phone application.

4. The method of claim 3, wherein a set of remaining expert media-content files are sequentially communicated to the user-side application based on the ranked index of the set of expert-media content files.

5. The method of claim 4, wherein the server implements steps for a predictive approach to buffering that utilizes pockets of time to pre-fetch content from expert advice media server.

6. The method of claim 5, wherein the steps for a predictive approach to buffering that utilizes pockets of time to pre-fetch content from expert advice media server further comprises:
before each expert media content session is rendered to the user, causing a jingle to play on the user's mobile device;
and, while the jingle is being played, downloading a next expert-media content file to be played.

7. The method of claim 6 further comprising:
detecting that the user's mobile device is connected to a broadband network; and
automatically pre-fetching the next expert-media content file to be played.

8. The method of claim 7, wherein the set of user attributes comprises a static user attributes, situational user attributes and behavioral user attributes.

9. The method of claim 8,
wherein the static user attribute comprises a demographic attributes,
wherein the situational user attribute comprises a current user professional state, and
wherein behavioral user attribute comprises a user hobby.

10. The method of claim 8 further comprising:
tracking a user history of consuming expert media content;
updating the user attributes based on the user history.

11. The method of claim 10 further comprising:
determining a current user context, wherein the current user context comprises a current user activity, a forthcoming user activity or a user location; and
matching a current user context with a relevant expert-media content.

12. The method of claim 11 further comprising:
pushing a notification to the user's mobile device, wherein the notification comprises a notice to the user that the relevant expert-media content is available for the user to consume.

13. A computerized system implemented by at least one server comprising:
a processor configured to execute instructions;
a memory containing instructions when executed on the processor, causes the processor to perform operations that:
obtain a set of expert-media content files and an index of the set of expert-media content files;
obtain a set of user attributes;
receive a request from a user-side application to download an expert-media content file;
store the set of expert-media content files, the index of the set of expert-media content files in a computer data store, the request to download the expert-media content file and the set of user attributes in a computerized data store;
with the processor of a server implementing delivering predictive expert-media content to the user's mobile device:
extract the set of expert-media content files, the index of the set of expert-media content files in a computer data store, the request to download the expert-media content file and the set of user attributes in a computerized data store;
with a recommendation engine operating in the server, rank the index of the set of expert media-content files based on the set of user attributes; and
obtain a first-listed expert media-content file of the ranked index of the set of expert-media content files; and
electronically communicate the first-listed expert media-content file to the user-side application.
